(19) United States
(12) Patent Application Publication
(10) Pub. No.: US 2015/0288763 A1
(43) Pub. Date: Oct. 8, 2015

(54) REMOTE ASYMMETRIC TCP CONNECTION OFFLOAD OVER RDMA

(71) Applicant: Strato Scale Ltd., Herzlia (IL)

(72) Inventors: Liaz Kamper, Ra'anana (IL); Etay Bogner, Tel Aviv (IL)

(21) Appl. No.: 14/672,305

(22) Filed: Mar. 30, 2015

Related U.S. Application Data
(60) Provisional application No. 61/973,976, filed on Apr. 2, 2014.

(51) Int. Cl. H04L 29/08; H04L 29/06

(52) U.S. Cl. CPC H04L 67/1097; H04L 69/161

(57) ABSTRACT

A method includes, in a source server, generating data that is to be sent over a Transmission Control Protocol (TCP) connection to a destination server. The data is transferred from the source server to an offload server using Remote Direct Memory Access (RDMA), while bypassing a local TCP stack of the source server. The data is assembled in the offload server in accordance with the TCP, and the assembled data is forwarded over the TCP connection to the destination server.

### CROSS-REFERENCE TO RELATED APPLICATIONS

This application claims the benefit of U.S. Provisional Patent Application 61/973,976, filed Apr. 2, 2014, whose disclosure is incorporated herein by reference.

### FIELD OF THE INVENTION

The present invention relates generally to computer networks, and particularly to methods and systems for TCP offload.

### BACKGROUND OF THE INVENTION

Communication in computer networks is commonly carried out using the Transmission Control Protocol (TCP). Handling of TCP protocol-stack operations by the Central Processing Unit (CPU) of the TCP endpoint incurs considerable latency, as well as CPU and memory overhead. One solution for reducing this overhead is using Remote Direct Memory Access (RDMA). RDMA is specified, for example, in Request for Comments (RFC) 5040 of the Internet Engineering Task Force (IETF), entitled “A Remote Direct Memory Access Protocol Specification,” October, 2007, which is incorporated herein by reference. The IETF also proposes a Shared Memory Communications over RDMA (SMC-R) protocol that provides RDMA communications to TCP endpoints, in an Internet Draft entitled “Shared Memory Communications over RDMA,” July, 2012, which is incorporated herein by reference.

### SUMMARY OF THE INVENTION

An embodiment of the present invention that is described herein provides a method including, in a source server, generating data that is to be sent over a Transmission Control Protocol (TCP) connection to a destination server. The data is transferred from the source server to an offload server using Remote Direct Memory Access (RDMA), while bypassing a local TCP stack of the source server. The data is assembled in the offload server in accordance with the TCP, and the assembled data is forwarded over the TCP connection to the destination server.

In some embodiments, the destination server does not support RDMA. In some embodiments, the method includes synchronizing a state of the TCP connection between the offload server and the local TCP stack of the source server. In an embodiment, assembling the data in the offload server includes formatting the data in TCP segments having respective sequence numbers, and synchronizing the state of the TCP connection includes reporting the sequence numbers to the local TCP stack of the source server.

In an embodiment, forwarding the data over the TCP connection includes retransmitting failed TCP transmissions from the offload server to the destination server. In an embodiment, the method includes deciding in the source server, per TCP connection, whether to offload sending of the data to the offload server or to send the data using the local TCP stack. In another embodiment, the method includes processing incoming traffic from the destination server to the source server using the local TCP stack, while bypassing or passing-through the offload server.

There is additionally provided, in accordance with an embodiment of the present invention, a system including a source server and an offload server. The source server is configured to generate data that is to be sent over a Transmission Control Protocol (TCP) connection to a destination server, and to transfer the data over a network using Remote Direct Memory Access (RDMA), while bypassing a local TCP stack of the source server. The offload server is configured to assemble the data in accordance with the TCP, and to forward the assembled data over the TCP connection to the destination server.

There is also provided, in accordance with an embodiment of the present invention, a method including receiving in an offload server, using Remote Direct Memory Access (RDMA), data that has been generated in a source server for sending over a Transmission Control Protocol (TCP) connection to a destination server. The data is assembled in the offload server in accordance with the TCP, and the assembled data is forwarded over the TCP connection to the destination server.

In some embodiments, the method includes synchronizing a state of the TCP connection between the offload server and a local TCP stack of the source server. In some embodiments, the method includes forwarding incoming traffic from the destination server to the source server, while bypassing or passing-through the offload server.

There is further provided, in accordance with an embodiment of the present invention, apparatus including first and second network interfaces, and a processor. The first network interface is configured for communicating with a source server using Remote Direct Memory Access (RDMA). The second network interface is configured for communicating with a destination server using Transmission Control Protocol (TCP). The processor is configured to receive over the first network interface, using RDMA, data that has been generated in the source server for sending over a TCP connection to the destination server, to assemble the data in accordance with the TCP, and to forward the assembled data using the second network interface over the TCP connection to the destination server.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system that uses RDMA-based TCP offload, in accordance with an embodiment of the present invention; and

FIG. 2 is a flow chart that schematically illustrates a method for TCP offloading over RDMA, in accordance with an embodiment of the present invention.

### DETAILED DESCRIPTION OF EMBODIMENTS

### Overview

Embodiments of the present invention that are described herein provide improved methods and systems for offloading TCP processing in data centers and other computing systems. In some embodiments, a computing system comprises multiple servers that communicate using TCP, either with other servers in the system or with external servers. The system further comprises at least one offload server for offloading TCP connection processing from the servers. Typically, although not necessarily, the offload server is located at the edge of the computing system, and is configured to offload the processing of outgoing TCP traffic destined to external servers. The offload server may be implemented, for example, in a network switch or in a reverse proxy server.

In an embodiment, a given server, referred to as a source server, generates data that is to be sent over a TCP connection to some destination server. The source server transfers the data to the offload server using RDMA. The offload server sets up a TCP connection with the destination server, assembles the data into TCP segments, and sends the TCP segments to the destination server over the TCP connection.

The offload server typically manages various TCP data-flow mechanisms, e.g., retransmission and mitigation of out-of-order segment arrival, as well as management tasks such as connection setup and teardown. Since the outgoing data is transferred from the source server to the offload server using RDMA, the Central Processing Unit (CPU) of the source server is offloaded of outgoing TCP processing.

Typically, the source server runs a local TCP stack, which is bypassed when sending outgoing data to the offload server. Nevertheless, the offload server and the local TCP stack of the source server coordinate the TCP connection state with one another. For example, the offload server notifies the source server of the sequence numbers of the TCP segments, and the source server updates its local TCP stack accordingly.

It should be noted that, in some embodiments, RDMA communication is confined to the internal communication between the source server and the offload server. Communication between the offload server and the external destination server is often performed over a network that does not support RDMA, e.g., over the Internet. Therefore, the disclosed techniques are able to perform TCP offloading over RDMA, even when the destination server does not support RDMA at all.

The methods and systems described herein are highly effective in asymmetrical scenarios, in which high TCP traffic volume flows from the computing system to external servers, and only small traffic volume flows into the system. Asymmetrical traffic of this sort is common, for example, in data centers that serve content to external servers. In such cases, outgoing traffic comprises high-bandwidth content, whereas incoming traffic is mostly made-up of requests and acknowledgements. Nevertheless, the disclosed techniques are applicable in various other systems and use-cases.

### System Description

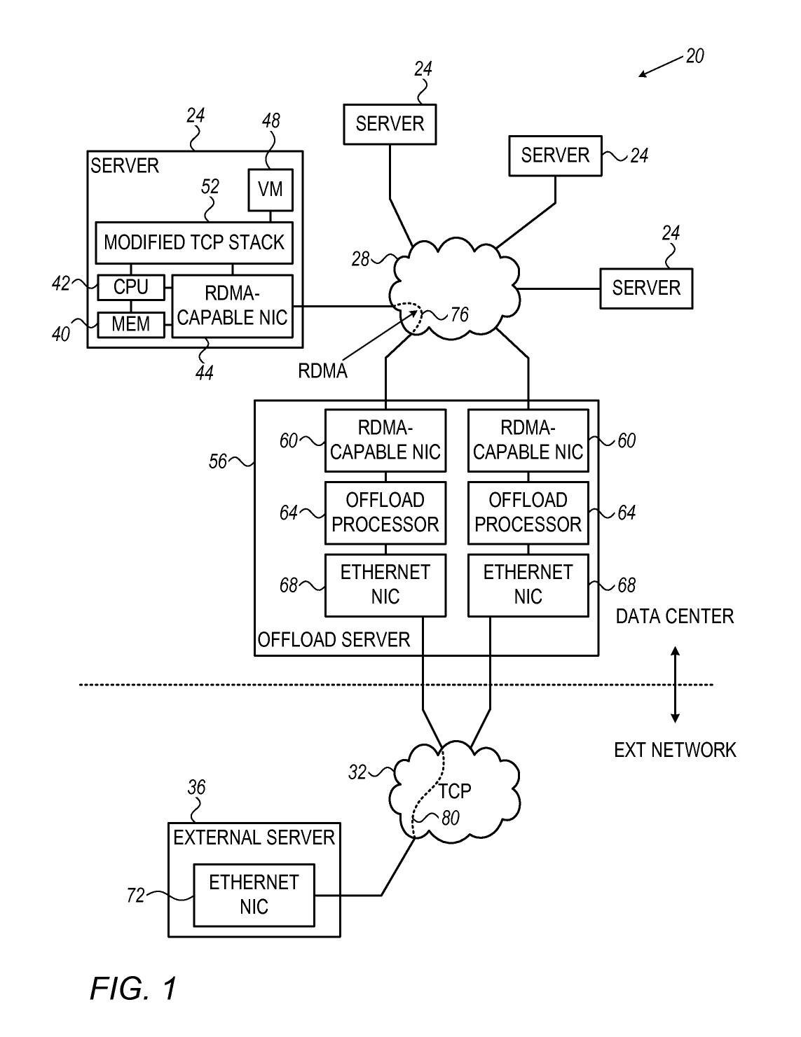

FIG. 1 is a block diagram that schematically illustrates a computing system 20 that uses RDMA-based TCP offload, in accordance with an embodiment of the present invention. System 20 may comprise, for example, a data center, a cloud computing system, a High-Performance Computing (HPC) system or any other suitable system.

System 20 comprises multiple servers 24. In the context of the present patent application and in the claims, the term “server” refers to any suitable type of computing platform or compute node. System 20 may comprise any suitable number of servers 24, either of the same type or of different types, or even only a single server. Servers 24 are connected by a communication network 28, typically a Local Area Network (LAN). Network 28 may operate in accordance with any suitable network protocol.

Each server 24 comprises a Central Processing Unit (CPU) 42. Depending on the type of server, CPU 42 may comprise multiple processing cores and/or multiple Integrated Circuits (ICs). Regardless of the specific server configuration, the processing circuitry of the server as a whole is regarded herein as the server CPU.

Each server 24 further comprises a memory 40, typically a volatile Random Access Memory (RAM), and an RDMA-capable Network Interface Card (NIC) 44 for communicating over network 28. Among other tasks, NIC 44 is used for offloading TCP processing using methods that are described below.

Each server 24 also runs a modified TCP stack 52. Server 24 typically maintains a respective TCP stack instance for each bidirectional TCP connection. In some embodiments, when processing virtualized traffic of a given VM 48, modified TCP stack 52 runs inside the VM. When processing traffic of the server, runs outside the VM in the context of the server.

Typically, each server 24 runs one or more clients, also referred to as workloads. In the present example, the clients comprise Virtual Machines (VMs) 48. Alternatively, however, clients may comprise, for example, user applications, operating-system processes or containers, or any other suitable type of client or workload. The description that follows refers to VMs, for the sake of clarity, but the disclosed techniques can be used in a similar manner with any other suitable types of clients or workloads.

System 20 comprises one or more offload servers 56, which offload TCP processing tasks from CPUs 42 of servers 24. In the present example, offload servers 56 are located at the edge of system 20, i.e., connect system 20 to an external network 32 such as the Internet. Alternatively, however, one or more offload servers 56 may be positioned in any other suitable manner, not necessarily at the edge of system 20. An offload server may also be implemented, for example, in a network switch or in a load-balancing server (e.g., a reverse proxy server that load-balances incoming requests to web servers and redirects the requests to a cluster of web servers).

Each offload server 56 comprises at least one RDMA-capable NIC 60, at least one offload processor 64, and at least one Ethernet NIC 68. RDMA-capable NICs 60 are used for communicating with servers 24 using RDMA. Offload processors 64 carry out the TCP offloading tasks described herein. Ethernet NICs 68 are used for communicating with external servers 36 over network 32. The external servers typically communicate using Ethernet NICs 72.

The system and server configurations shown in FIG. 1 are example configurations that are chosen purely for the sake of conceptual clarity. In alternative embodiments, any other suitable system and/or server configuration can be used. For example, it is not mandatory that all servers 24 necessarily comprise RDMA-capable NICs and/or run modified TCP stacks in accordance with the disclosed techniques.

The various elements of system 20, and in particular the elements of servers 24 and offload servers 56, may be implemented using hardware/firmware, such as in one or more Application-Specific Integrated Circuit (ASICs) or Field-Programmable Gate Array (FPGAs). Alternatively, some system or server elements, e.g., CPUs 44 and/or offload processors 64, may be implemented in software or using a combination of hardware/firmware and software elements.

In some embodiments, offload server 56 is implemented as a network appliance that conveys RDMA and Ethernet traffic upstream (from network 32 into system 20), and conveys Ethernet traffic downstream (from system 20 to network 32). This network appliance may run on any suitable physical computing platform. In some embodiments the offload server is implemented as part of another network device, such as a router or firewall.

In some embodiments, CPUs 44 and/or offload processors 64 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Offloading TCP Processing to Offload Server Using RDMA

In some embodiments, VMs 48 generate data that is to be sent over TCP connections from system 20 to external servers 36. For example, system 20 may comprise a data center that serves requested content to the external servers. Offload server 56 mediates between servers 24 and external servers 36, and offloads the processing of outgoing TCP traffic from CPUs 42 of servers 24.

In a typical flow, a certain VM 48 generates data that is to be sent over a TCP connection to a certain external server 36. Instead of using local TCP stack 52 for generating the outgoing TCP traffic, server 24 transfers the data generated by the VM to offload server 56 using RDMA.

The data is thus transferred over an RDMA connection 76 between RDMA-capable NICs 44 (in server 24) and 60 (in offload server 56). Typically, NICs 44 and 60 transfer the data directly from memory 40 of server 24 to a memory of offload server 56, for processing by offload processor 64, without involving or loading CPU 42.

In offload server 56, processor 60 assembles the data into TCP traffic, and sends the TCP traffic via NIC over a TCP connection 80 to external server 36. Typically, processor 64 assembles the data into one or more TCP segments, assigns the TCP segments respective sequence numbers, and sends the TCP segments over TCP connection 80.

Processor 60 typically also handles various TCP data-flow tasks of the TCP connection, such as receiving acknowledgements from external server 36, retransmitting TCP segments that were not received properly at the external server, and handling of out-of-order segment arrival. Further additionally, processor 60 may handle management tasks such as TCP options flags, handshake and connection setup and teardown. Thus, offload processor 60 effectively manages the state of TCP connection 80.

Typically, offload processor 60 coordinates and synchronizes the TCP connection state with local TCP stack 52 of server 24, so that local TCP stack 52 is able to maintain and track the connection state properly. For example, in some embodiments offload processor 60 updates TCP stack 52 with the sequence numbers it assigns to the TCP segments sent to external server 36.

Typically, the disclosed offloading scheme, including bypassing of the local TCP stack, is applied to traffic that is sent from servers 24 to external servers 36. TCP traffic exchanged between servers 24, internally to system 20, may be offloaded to RDMA in both directions without involving offload server 56. Incoming TCP traffic, from external servers 36 to servers 24, typically bypasses or passes through offload server 56 without processing, and is handled by the local TCP stacks of the receiving servers 24.

In some embodiments, CPU 42 of the source server may decide, per TCP connection, whether to handle the outgoing traffic conventionally using the local TCP stack or to offload the processing to offload server 56.

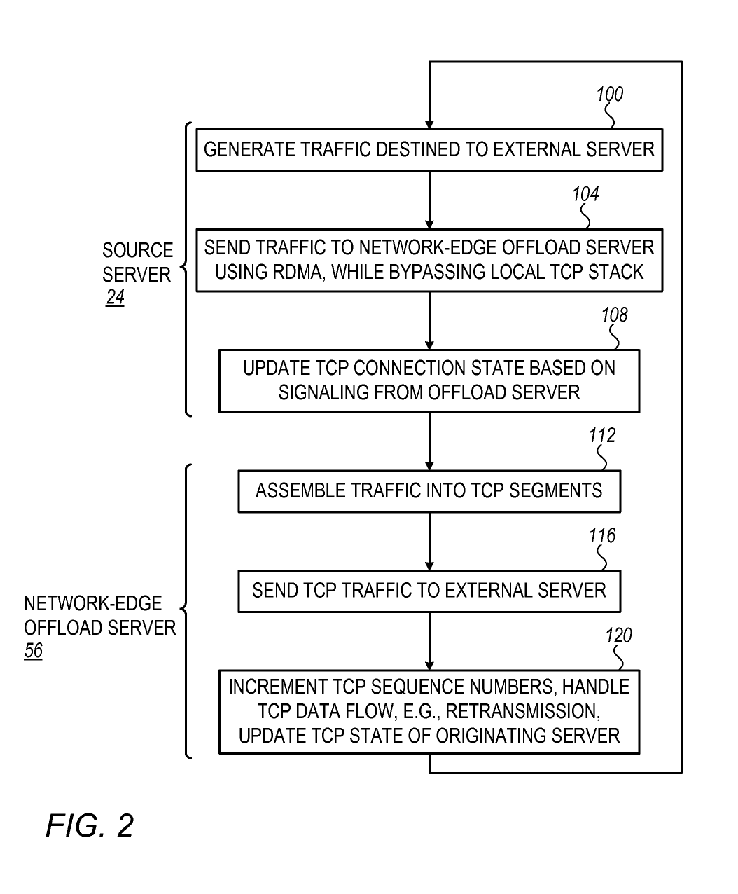

FIG. 2 is a flow chart that schematically illustrates a method for TCP offloading over RDMA, in accordance with an embodiment of the present invention. The method begins with source server 24 generating data destined to external server 36, at a data generation step 100.

Server 24 transfers the data to offload server 56 using RDMA, at an RDMA transfer step 104. At a state updating step 108, server 24 updates its local TCP stack 52 with the state of the TCP connection between offload server 56 and external server 36, as reported by the offload server.

Offload server 56 assembles the data received from server 24 into TCP segments, at a segment assembly step 112. The offload server sends the TCP segments over the TCP connection to external server 36, at a TCP transmission step 116. At a state maintenance step 120, the offload server maintains the state of the TCP connection. Maintenance may comprise, for example, incrementing of segment sequence numbers, handling retransmissions, segment reordering and other TCP processing functions. The offload server also notifies the local TCP stack of the source server of any updates in the TCP connection state.

Although the embodiments described herein refer mainly to TCP offloading over RDMA, the disclosed techniques are not limited to these specific protocols and can be used with other suitable protocols. For example, the disclosed techniques can be used for offloading connection-oriented protocols other than TCP, over high-speed networks other than RDMA, e.g., Peripheral Component Interconnect Express (PCIe).

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a source server, generating data that is to be sent over a Transmission Control Protocol (TCP) connection to a destination server;
transferring the data from the source server to an offload server using Remote Direct Memory Access (RDMA), while bypassing a local TCP stack of the source server;
assembling the data in the offload server in accordance with the TCP, and forwarding the assembled data over the TCP connection to the destination server.

2. The method according to claim 1, wherein the destination server does not support RDMA.

3. The method according to claim 1, and comprising synchronizing a state of the TCP connection between the offload server and the local TCP stack of the source server.

4. The method according to claim 3, wherein assembling the data in the offload server comprises formatting the data in TCP segments having respective sequence numbers, and wherein synchronizing the state of the TCP connection comprises reporting the sequence numbers to the local TCP stack of the source server.

5. The method according to claim 1, wherein forwarding the data over the TCP connection comprises retransmitting failed TCP transmissions from the offload server to the destination server.

6. The method according to claim 1, and comprising deciding in the source server, per TCP connection, whether to offload sending of the data to the offload server or to send the data using the local TCP stack.

7. The method according to claim 1, and comprising processing incoming traffic from the destination server to the source server using the local TCP stack, while bypassing or passing-through the offload server.

8. A system, comprising:
a source server, which is configured to generate data that is to be sent over a Transmission Control Protocol (TCP) connection to a destination server, and to transfer the data over a network using Remote Direct Memory Access (RDMA), while bypassing a local TCP stack of the source server; and
an offload server, which is configured to assemble the data in accordance with the TCP, and to forward the assembled data over the TCP connection to the destination server.

9. The system according to claim 8, wherein the destination server does not support RDMA.

10. The system according to claim 8, wherein the offload server and the local TCP stack of the source server are configured to synchronize a state of the TCP connection with one another.

11. The system according to claim 10, wherein the offload server is configured to format the data in TCP segments having respective sequence numbers, and to report the sequence numbers to the local TCP stack of the source server.

12. The system according to claim 8, wherein the offload server is configured to retransmit failed TCP transmissions to the destination server.

13. The system according to claim 8, wherein the source server is configured to decide, per TCP connection, whether to offload sending of the data to the offload server or to send the data using the local TCP stack.

14. The system according to claim 8, wherein the source server is configured to process incoming traffic from the destination server to the source server using the local TCP stack, while bypassing or passing-through the offload server.

15. A method, comprising:
receiving in an offload server, using Remote Direct Memory Access (RDMA), data that has been generated in a source server for sending over a Transmission Control Protocol (TCP) connection to a destination server;
assembling the data in the offload server in accordance with the TCP; and
forwarding the assembled data over the TCP connection to the destination server.

16. The method according to claim 15, and comprising synchronizing a state of the TCP connection between the offload server and a local TCP stack of the source server.

17. The method according to claim 15, and comprising forwarding incoming traffic from the destination server to the source server, while bypassing or passing-through the offload server.

18. Apparatus, comprising:
a first network interface for communicating with a source server using Remote Direct Memory Access (RDMA);
a second network interface for communicating with a destination server using Transmission Control Protocol (TCP); and
a processor, which is configured to receive over the first network interface, using RDMA, data that has been generated in the source server for sending over a TCP connection to the destination server, to assemble the data in accordance with the TCP, and to forward the assembled data using the second network interface over the TCP connection to the destination server.

19. The apparatus according to claim 18, wherein the processor is configured to synchronize a state of the TCP connection with a local TCP stack of the source server.
